(19) United States
(12) Patent Application Publication
(10) Pub. No.: US 2006/0075653 A1
(43) Pub. Date: Apr. 13, 2006

(54) Tape rule housing structure

(76) Inventor: Shih-Lin Lee, Taipei (TW)

Correspondence Address: APEX JURIS, PLLC, LAKE CITY CENTER, SUITE 410, 12360 LACE CITY WAY NORTHEAST, SEATTLE, WA, 98125, US

(21) Appl. No.: 11/258,724

(22) Filed: Oct. 25, 2005

Related U.S. Application Data
(63) Continuation-in-part of application No. 10/808,851, filed on Mar. 25, 2004, now abandoned.

(51) Int. Cl. G01B 3/10

(52) U.S. Cl. 33/767

(57) ABSTRACT

The outer surface of a tape rule proper of an improved tape rule housing structure is adhered with a leather or fibrous cloth using a binder so that the user is easy to grip without the worry of slipping, and also contributes to enhancing visually appealing look of the tape rule. The leather or fibrous cloth can be adhered to any portion on the surface of the tape rule such as the juncture and edges of the housing.

### REFERENCE TO EARLIER FILED APPLICATION

This application repeats a substantial portion of prior application Ser. No. 10/808,851, filed on Mar. 25, 2004, and adds and claims additional disclosure not presented in the prior application. Since this application names the sole inventor in the prior application, it constitutes a continuation-in-part of the prior application and Applicant claims priority to the previously filed application.

### BACKGROUND OF THE INVENTION

1. Field of the Invention

The present invention related to an improved tape rule housing structure and more particularly, to a tape rule housing whose outer surface is adhered with a layer of leather or fibrous cloth so as to assure a good grip feeling without slipping, and improved sense of touch and good appearance for the whole structure.

2. Description of the Prior Art

In a first cited case U.S. Pat. No. 5,746,004 “Tape Rule Housing”, the characteristic of the disclosure is described as: A returnable tape rule housing comprising: (a) side walls; (b) a peripheral wall extending therebetween with a bottom portion, upper portion, front end portion, and rear end portion, said walls providing an internal chamber there within, said peripheral wall having an aperture therein communicating with said chamber at the juncture between said bottom portion and said front end portion for passage of a tape rule blade therethrough, the juncture between said side walls and said upper portion of said peripheral wall being generally convexly accurate, said housing walls having recessed portions extending over the upper section of said rear end portion and the rearward portion of said peripheral wall and the adjacent portion of said side walls, said housing side wall and peripheral wall being fabricated from synthetic resin and being provided by a pair of mating housing elements; and (c) an elastomeric grip element seated in said recessed portions and extending over the upper section of said rear end portion and the rearward section of said upper portion of said peripheral wall and said adjacent portions of said side walls, and said grip element being adhesively bonded to said peripheral wall and said walls, said grip element having ribs extending transversely of said peripheral wall and spaced along the length thereof, said grip element providing a slip resistant and comfortable gripping surface for the user's palm and thumb.

Meanwhile, in the above cited case, the grip element is only extending over the upper section of said rear end portion and the rearward section of said upper portion of said peripheral wall and said adjacent portions of said side walls instead of entirely covering the tape rule housing so that only a limited slip resistance and comfortable gripping feeling can be expected when the user grips with his/her hand.

In other two cited cases, disclosed by U.S. Pat. No. 6,216,356 “Clasping Structure of the Tapeline Anti-Skidding Pad” (Cited case 2), and U.S. Pat. No. 6,182,916 “Measuring Tape Dispenser with an Impact Buffer Housing and Tentative Tape Halting Means” (Cited case 3), each of them disclosed a type of anti-skidding tape rule structure respectively. However, they have a common feature that a rubber anti-skidding pad is employed to clasp onto the tape rule housing. With such clasping means, it is impossible for the user to grasp the tape rule housing firmly enough to avoid slipping of the tape rule housing away from his/her hand.

For these shortcomings noticeable on the prior art, an improvement is seriously required.

The inventor has plunged into this matter with great efforts for years to studying and improving these shortcomings and come up with another novel tape rule housing structure provided by this invention to eliminate the shortcomings mentioned above.

### SUMMARY OF THE INVENTION

Accordingly, the main object of the present invention is to provide an anti-skidding tape rule housing structure.

Another object of the present invention is to provide an improved tape rule housing structure which has a colorful appearance.

Still another object of the present invention is to provide an improved tape rule housing structure which has a comfortable sense of touch and smart outward appearance.

To achieve these and other objects described above, the tape rule housing structure of a tape rule proper is formed of mutually coupled first subhousing and second subhousing, and a tape exit opened at the bottom end between the front side walls, and a brake shoe is provided at the upper front end of the hosing thereof for controlling the motion of the tape. An anti-skidding leather or fibrous cloth is adhesively attached to the juncture of the two subhousings or on any recessed surface of the housing so as to assure firm gripping of the tape rule housing by the user's hand. The leather or fibrous cloth can be differently colored from the tape rule proper so as to exhibit an easy-on-eye looking.

These features and advantages of the present invention will be fully understood and appreciated from the following detailed description of the accompanying Drawings.

### BRIEF DESCRIPTION OF THE DRAWINGS

FIG. 1 is a perspective view of the tape rule proper with stripped leather or fibrous cloth in a first embodiment of the present invention;

FIG. 2 is a perspective view of a completed tape rule proper in a first embodiment of the present invention;

FIG. 3 is a fragmentary exploded view of the tape rule proper in a second embodiment thereof;

FIG. 4 is a perspective view of a completed tape rule proper in a second embodiment thereof;

FIG. 5 is a perspective view of a completed tape rule proper in a third embodiment thereof;

FIG. 6 is a perspective view of a completed tape rule proper in a fourth embodiment thereof;

FIG. 7 is a perspective view of a completed tape rule proper in a fifth embodiment thereof; and

FIG. 8 is an illustrative view demonstrating the operation of the tape rule according to the present invention.

### DETAILED DESCRIPTION OF THE PREFERRED EMBODIMENTS

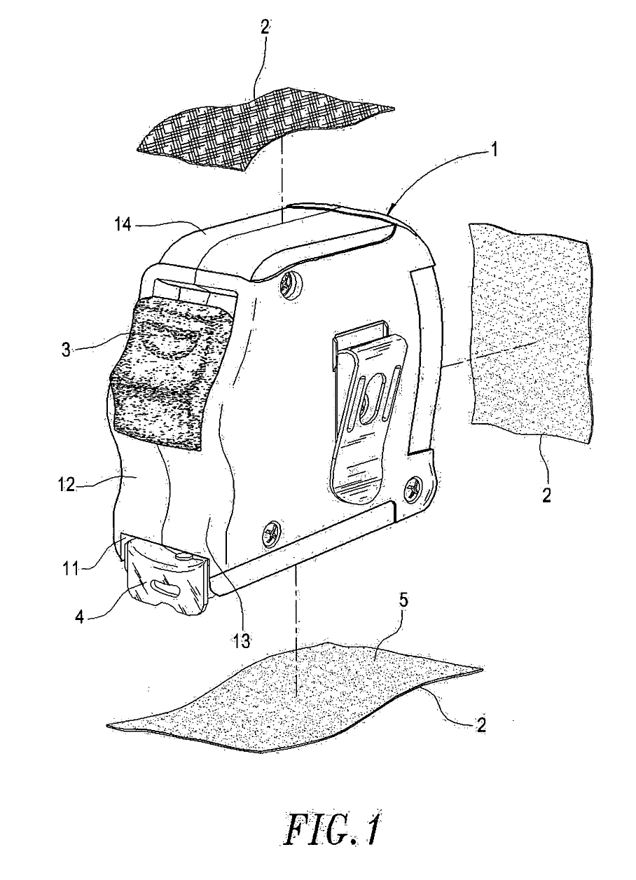

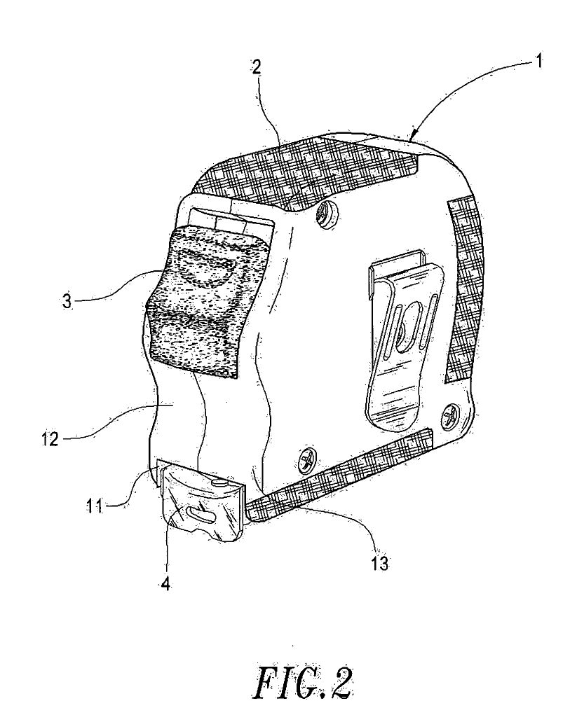

Referring to FIGS. 1 and 2 which show respectively a first embodiment of the present invention in two aspects, the improved structure of the tape rule housing structure has a tape rule proper 1 formed of mutually coupled first subhousing 12 and second subhousing 13, and a tape exit 11 opened at the bottom end between two front side walls of the tape rule proper. Moreover, a brake shoe 3 is provided at the upper front end of the tape rule proper thereof for controlling the motion of a tape 4, and at least one recessed portion 14 is formed discretionarily on the tape rule proper 1.

The recessed portion or portions 14 is covered by adhering a leather or fibrous cloth 2 using a binder 5 so as to keep the surface of the tape rule proper 1 flat and smooth.

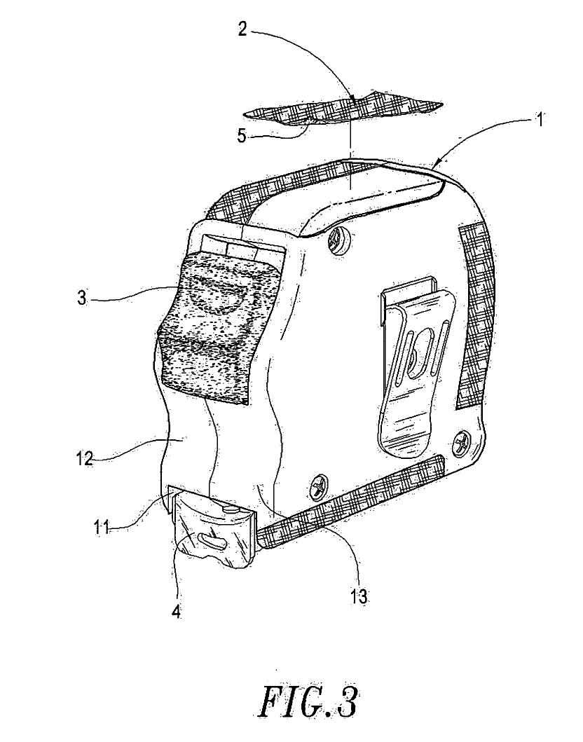

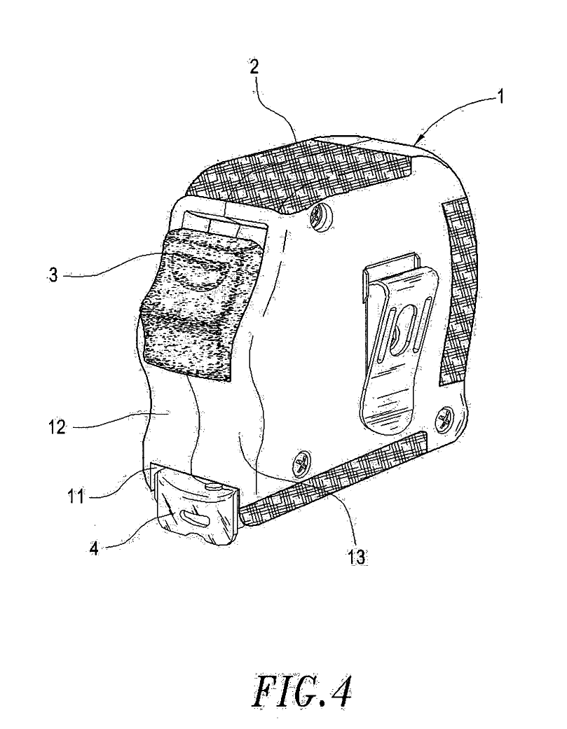

Referring to FIGS. 3 and 4, in a second embodiment of the present invention, the leather or fibrous cloth 2 is attached with the binder 5 to the juncture of the two subhousings 12 and 13 or on any recessed surface of the housing such that the user may firmly grip onto the housing without slipping.

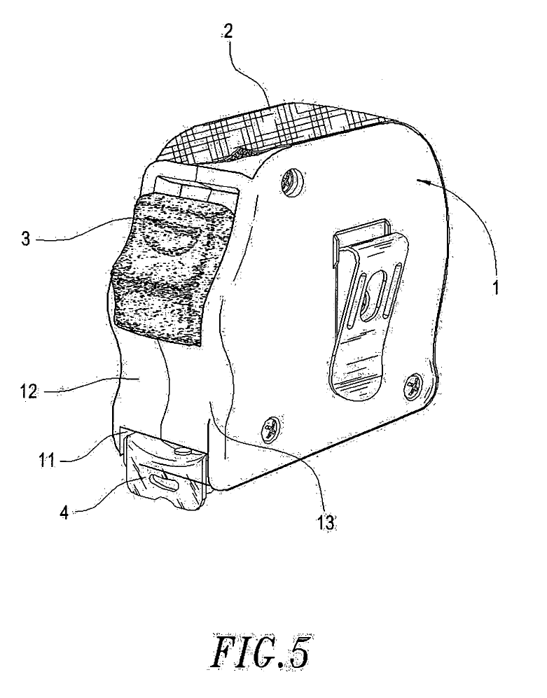

Referring to FIG. 5, in a third embodiment of the present invention, the leather or fibrous cloth 2 can be directly adhered to any flat surface of the tape rule proper 1 with the binder 5 so as to emerge the leather or fibrous cloth 2 out of the surface of the tape rule proper 1 thereby aftaining the skid proof effect.

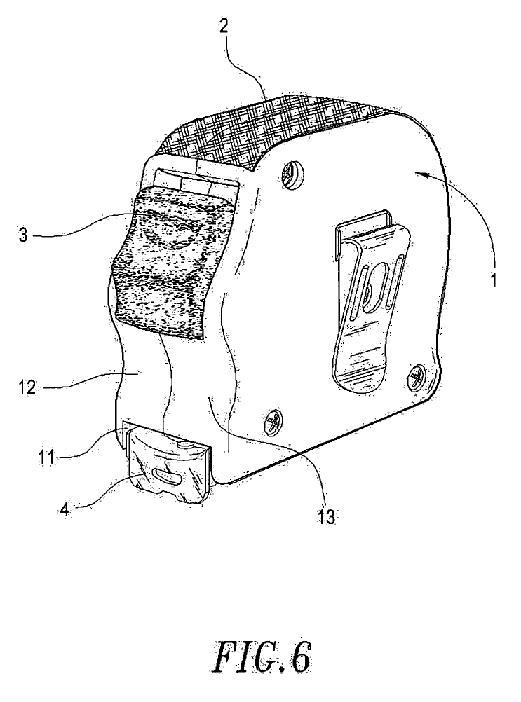

Referring to FIG. 6, in a fourth embodiment of the present invention, the leather or fibrous cloth 2 is respectively adhered to the flat surfaces of the first and second tape rule subhousings 12, 13 of the tape rule proper 1 with the binder 5 so as to expose the leather or fibrous cloth 2 on the surface of the tape rule proper 1 thereby attaining the skid proof effect.

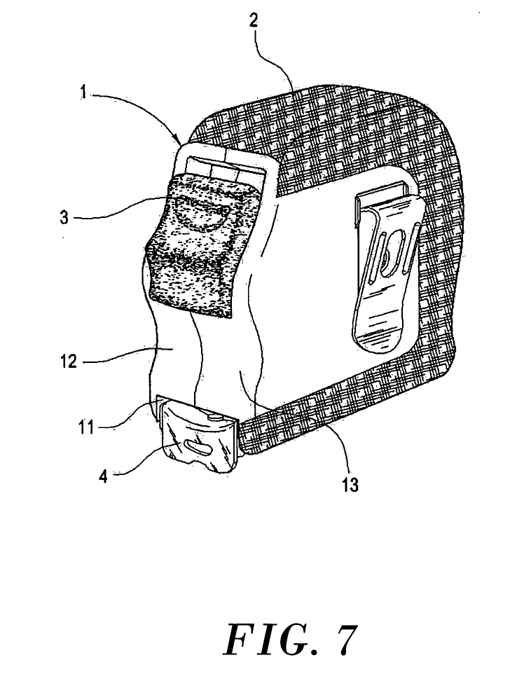

Referring to FIG. 7, in a fifth embodiment of the present invention, the leather or fibrous cloth 2 is used to shade all the screw holes on the tape rule proper 1 and the juncture between the first tape rule subhousing 12 and the second tape rule subhousing 13 so as to give the tape rule proper 1 a comfortable sense of touch and a pleasant outward looking.

Besides, the leather orfibrous cloth 2 can be differently colored to enhance visually appealing look.

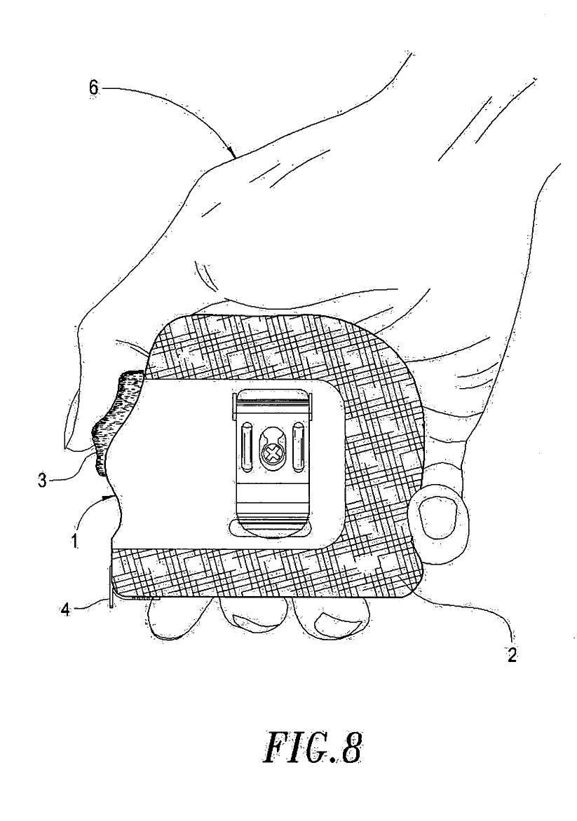

Referring to FIG. 8, when operating the tape rule, the user can grasp the tape rule proper 1 in his/her palm 6 at the surface where the leather or fibrous cloth 2 is attached so as to obtain an anti-skidding effect.

It emerges from the above description that the improved tape rule housing structure according to the present invention has several merits compared with the prior products cited above, namely:

1. Using the leather or fibrous cloth adhered on the surface of the tape rule proper ensures an anti-skidding effect when the user grasps the tape rule by hand.

2. Differently colored leather or fibrous cloth contributes to heightening visually appealing look of the tape rule.

Many changes and modifications in the above described embodiments of the invention can, of course, be carried out without departing from the scope thereof. Accordingly, to promote the progress in science and the useful arts, the invention is disclosed and is intended to be limited only by the scope of the appended claims.

It is understood that the present invention is a high level technical creation and by no means, simply utilizes conventional technology or knowledge known prior to the application for patent, or can easily made by persons skilled in the arts. Prior to the application for patent, the invention has neither been published or put to public use, nor displayed in any exhibition, therefore the present invention is entitled for patent.

What is claimed is:

1. Improved tape rule housing structure comprising:
a tape rule proper formed of mutually coupled first subhousing and second subhousing, and a tape exit opened at the bottom end between two front side walls of said tape rule proper, moreover, a brake shoe being provided at the upper front end of said tape rule proper, wherein it is characterized that a leather cloth is adhered firmly to any portion of surface of said tape rule proper with a binder.

2. The improved tape rule housing structure of claim 1, wherein:
a recessed portion or portions is formed on the surface of said tape rule proper for adhering said leather cloth thereon so as to keep flush with the surface of said tape rule proper.

3. The improved tape rule housing structure of claim 1, wherein said leather cloth is emerged out of the surface of said tape rule proper.

4. The improved tape rule housing structure of claim 1, wherein said leather cloth is respectively adhered onto said first subhousing and said second subhousing of said tape rule proper.

5. The improved tape rule housing structure of claim 4, wherein said recessed portion or portions is formed on said first subhousing and said second subhousing of said tape rule proper for adhering said leather cloth thereon so as to keep flush with the surface of said tape rule proper.

6. The improved tape rule housing structure of claim 4, wherein said leather cloth is emerged out of the surfaces of said first subhousing and said second subhousing of said tape rule proper.

7. Improved tape rule housing structure comprising a tape rule proper formed of mutually coupled first subhousing and second subhousing, and a tape exit opened at the bottom end between two front side walls of said tape rule proper, moreover a brake shoe being provided at the upper front end of said tape rule proper, wherein it is characterized that a fibrous cloth is adhered firmly to any portion of surface of said tape rule proper with a binder.

8. The improved tape rule housing structure of claim 7, wherein a recessed portion or portions is formed on the surface of said tape rule proper for adhering said fibrous cloth thereon so as to keep flush with the surface of said tape rule proper.

9. The improved tape rule housing structure of claim 7, wherein said fibrous cloth is emerged out of the surface of said tape rule proper.

10. The improved tape rule housing structure of claim 7, wherein said fibrous cloth is respectively adhered onto said first subhousing and said second subhousing of said tape rule proper.

11. The improved tape rule housing structure of claim 10, wherein said recessed portion or portions is formed on said first subhousing and said second subhousing of said tape rule proper for adhering said fibrous cloth thereon so as to keep flush with the surface of said tape rule proper.

12. The improved tape rule housing structure of claim 10, wherein said fibrous cloth is emerged out of the surfaces of said first subhousing and said second subhousing of said tape rule proper.
